(19) United States
(12) Patent Application Publication
(10) Pub. No.: US 2009/0033646 A1
(43) Pub. Date: Feb. 5, 2009

(54) DISPLAY WITH A LUMINANCE AND COLOR TEMPERATURE CONTROL SYSTEM AND METHOD FOR CONTROLLING THE LUMINANCE OF A DISPLAY

(76) Inventors: Chao-Wen Liu, Hsinchu (TW); Chih-Kuo Lee, Hsinchu (TW)

Correspondence Address: NORTH AMERICA INTELLECTUAL PROPERTY CORPORATION, P.O. BOX 506, MERRIFIELD, VA, 22116, US

(21) Appl. No.: 12/106,340

(22) Filed: Apr. 21, 2008

(30) Foreign Application Priority Data
Aug. 3, 2007 (TW) 096128637

(51) Int. Cl. G09G 5/00; G09G 5/10; G09G 3/30

(52) U.S. Cl. 345/207; 345/690; 345/63; 345/77; 345/87

(57) ABSTRACT

A display includes a display module, a light source, a light source driving circuit, a display driving circuit, and an optical sensor. The optical sensor is installed next to the light source for detecting the luminance and color temperature of the light source. The optical sensor is coupled to the display driving circuit for generating a feedback signal to the display driving circuit according to the luminance and the color temperature of the light source. The display driving circuit drives the display module to display an image according to a received image signal and updates the data of the image signal according to the feedback signal so as to adjust the luminance and the color temperature of the image.

### BACKGROUND OF THE INVENTION

1. Field of the Invention

The present invention relates to a display, and more particularly, to a display with a luminance and color temperature control system.

2. Description of the Prior Art

Please refer to FIG. 1. FIG. 1 is a schematic diagram of a display 10 with the luminance control system according to the prior art. The display 10 includes a display module 11, a light source 12, a light source driving circuit 14, a display driving circuit 16, and an optical sensor 18. The display 10 sets a plurality of parameters of the color temperature, such as 6500 K or 9300 K. When the light source 12 is decayed, the color performance of the display 10 is influenced. The optical sensor 18 is installed next to the light source 12 for detecting the luminance of the light source 12. The optical sensor 18 is coupled to the light source driving circuit 14 and generates a feedback signal FB to the light source driving circuit 14 according to the luminance of the light source 12. The light source 12 includes a light-emitting diode (LED) module. The luminance of the LED may be adjusted by the driving voltage or the driving current. The light beams of a red light LED, a green light LED, and a blue light LED are mixed so as to generate the white light. The optical sensor 18 includes a red light detective unit, a green light detective unit, and a blue light detective unit so that the luminance of the red light, green light, and blue light is detected respectively, so the feedback signal FB includes a red light parameter, a green light parameter, and a blue light parameter. Thus, the light source driving circuit 14 may adjust the driving voltage or current to control individually the luminance of the red light LED, green light LED, and blue light LED according to the feedback signal FB so as to stabilize the color temperature of the display 10.

In conclusion, in order to stabilize the color temperature of the display, the optical sensor is installed next to the light source of the display according to the prior art. The optical sensor detects the luminance of the light source in real time and generates the feedback signal so that the light source driving circuit adjusts the luminance of the light source according to the feedback signal. In general, the light source includes a cold cathode fluorescent lamp (CCFL) or an LED module. The LED module generates the white light by mixing the light beams of the red light LED, the green light LED, and the blue light LED so that the light source driving circuit controls individually the luminance of the red light LED, the green light LED, and the blue light LED. However, if the light source uses the CCFL, the light source driving circuit may adjust merely the driving voltage or driving current to change the luminance of the white light. Thus, the display with the luminance control system according to the prior art is more suitable for the LED module than for the CCFL.

### SUMMARY OF THE INVENTION

It is therefore a primary objective of an embodiment of the claimed invention to provide a display with a luminance and color temperature control system and a method for controlling the luminance of a display for solving the above-mentioned problem.

An embodiment of the claimed invention provides a display with a luminance and color temperature control system, including a display module; a light source installed next to the display module; an optical sensor installed next to the light source for detecting the luminance and the color temperature of the light source so as to generate at least one feedback signal; and a display driving circuit coupled to the optical sensor for receiving an image signal so as to drive the display module to display an image and updating the data of the image signal according to the feedback signal.

An embodiment of the claimed invention further provides a method for controlling the luminance and the color temperature of a display, including detecting the luminance and the color temperature of a display so as to generate at least one feedback signal; and updating data of an image signal for driving the display according to the feedback signal so as to adjust the luminance and the color temperature of an image of the display.

An embodiment of the claimed invention further provides a display with a luminance and color temperature control system, including a display module for displaying an image and the display module having a display surface; an optical sensor installed on the display surface for detecting the luminance and the color temperature of the light source so as to generate at least one feedback signal; and a display driving circuit coupled to the optical sensor for receiving an image signal so as to drive the display module to display the image and updating data of the image signal according to the feedback signal.

Other objectives, features and advantages of the present invention will be further understood from the further technology features disclosed by the present invention wherein there are shown and described preferred embodiments of this invention, simply by way of illustration of modes best suited to carry out the invention.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a display with the luminance control system according to the prior art.

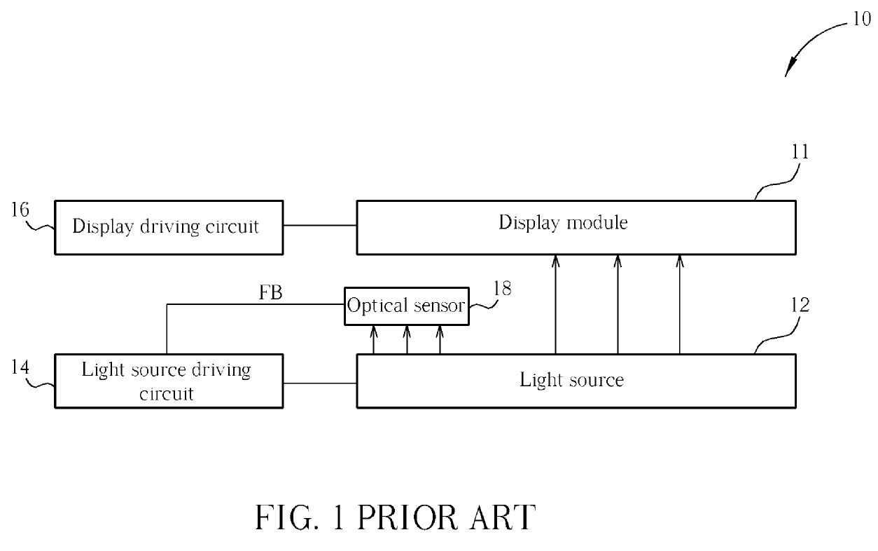

FIG. 2 is a schematic diagram of the first embodiment of a display with a luminance and color temperature control system according to the present invention.

FIG. 3 is a schematic diagram of the second embodiment of a display with a luminance and color temperature control system according to the present invention.

FIG. 4 is a schematic diagram of the display driving circuit in FIG. 2 processing the feedback signal.

FIG. 5 is a schematic diagram of the third embodiment of a display with a luminance and color temperature control system according to the present invention.

FIG. 6 is a schematic diagram of the fourth embodiment of a display with a luminance and color temperature control system according to the present invention.

### DETAILED DESCRIPTION

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

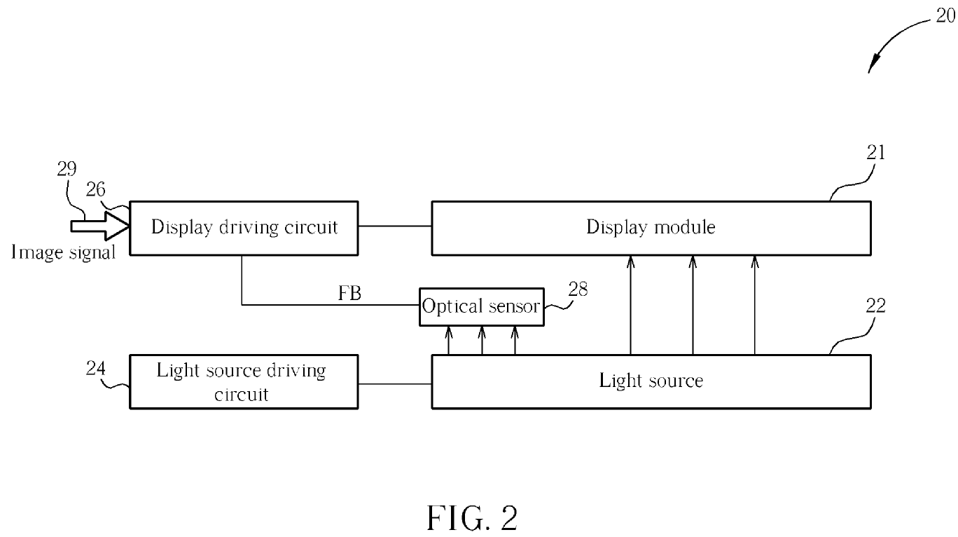

Please refer to FIG. 2. FIG. 2 is a schematic diagram of the first embodiment of a display 20 with a luminance and color temperature control system according to the present invention. The display 20 includes a display module 21, a light source 22, a light source driving circuit 24, a display driving circuit 26, and an optical sensor 28. The optical sensor 28 is installed next to the light source 22 for detecting the luminance and the color temperature of the light source 22. The optical sensor 28 is coupled to the display driving circuit 26 and generates a feedback signal FB to the display driving circuit 26 according to the luminance and the color temperature of the light source 22. The display driving circuit 26 receives an image signal 29 to drive the display module 21 for displaying an image, and the display driving circuit 26 updates the data of the received image signal 29 according to the feedback signal FB so as to adjust the luminance and the color temperature of the image.

In the first embodiment, the display driving circuit 26 is coupled to the optical sensor 28 and receives the feedback signal FB generated by the optical sensor 28. The display driving circuit 26 calculates a gain value for updating the data of the image signal 29 according to the feedback signal FB. Thus, when the luminance of the light source 22 is too bright or too dark, the display module 21 displays the image with the required luminance and the required color temperature by compensating the image signal 29. According to this embodiment, the display with the light source is suitable for use. For example, when a backlight of a liquid crystal display (LCD) decays, an optical sensor installed next to the backlight generates a feedback signal to a display driving circuit of the LCD, so that the display driving circuit updates data of an image signal according to the feedback signal so as to increase the luminance of the image to compensate the backlight. Similarly, a projector is suitable for use, too. When a light source of the projector is decayed, an optical sensor installed next to the light source generates a feedback signal to a data handling circuit of the projector, so that the display driving circuit updates data of an image signal according to the feedback signal so as to increase the luminance of the image to compensate the light source.

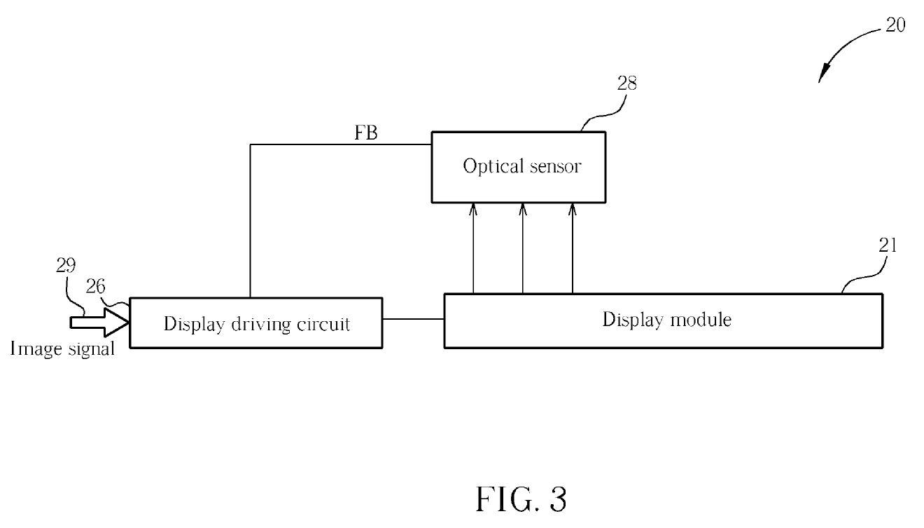

Please refer to FIG. 3. FIG. 3 is a schematic diagram of the second embodiment of a display with a luminance and color temperature control system according to the present invention. In the second embodiment, the optical sensor 28 is installed on a display surface of the display module 21 for detecting the luminance and the color temperature of the image generated by the display module 21. The optical sensor 28 is coupled to the display driving circuit 26. Thus, the display driving circuit 26 receives the feedback signal FB generated by the optical sensor 28 and calculates a gain value of the image signal 29 according to the feedback signal FB so as to update the data of the image signal 29. According to this embodiment, an LCD or a plasma display is suitable for use. The data of the image signal is updated by detecting the luminance and the color temperature of the display.

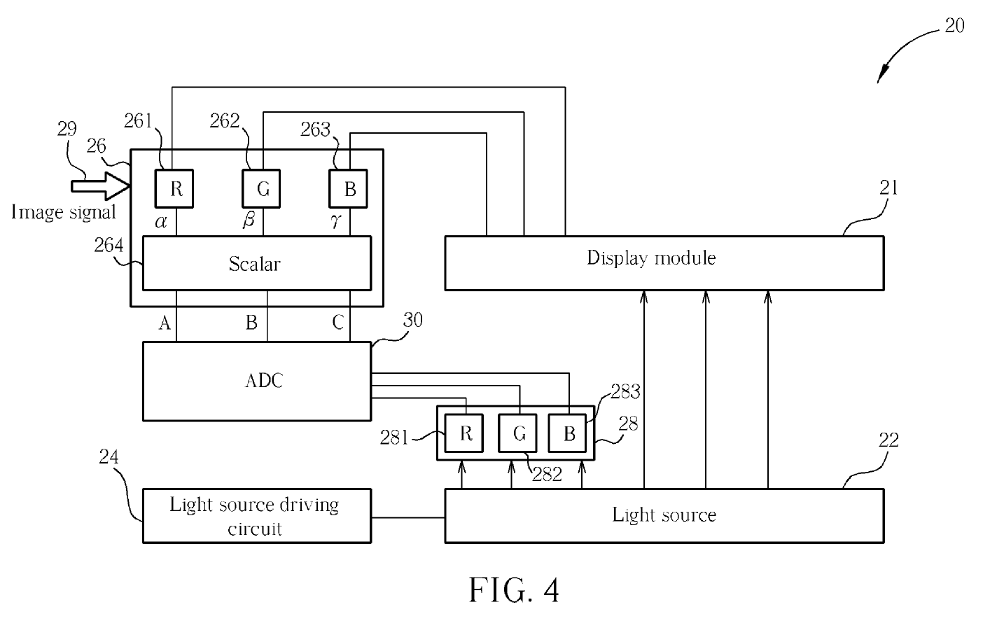

Please refer to FIG. 4. FIG. 4 is a schematic diagram of the display driving circuit 26 in FIG. 2 processing the feedback signal. The optical sensor 28 includes a red light detective unit 281, a green light detective unit 282, and a blue light detective unit 283 so that the luminance of the red light, green light, and blue light is detected respectively. The feedback signal FB generated by the optical sensor 28 is an analog signal. An analog-to-digital converter (ADC) 30 converts the feedback signal to a digital signal. The digital signal includes color parameters A, B, and C of the detected luminance of the red light, green light, and blue light respectively. The display driving circuit 26 includes a red channel 261, a green channel 262, and a blue channel 263 for receiving the red, green, and blue data of the image signal 29 respectively so as to display the red, green, and blue areas of the display module 21. The display driving circuit 26 further includes a scalar 264 for converting the color parameters A, B, and C of the digital signal to the gain value α, β, and γ of the luminance and the color temperature so as to update the data of the image signal 29. The scalar 264 has a transformation matrix as formula (9), and the transformation matrix can be obtained according to steps 200 to 240.

Step 200: assume predetermined three tri-stimulus values are X, Y, and Z;

$$\begin{matrix}[ \begin{matrix}X \\ Y \\ Z\end{matrix} ] = [ \begin{matrix}D 11 & D 12 & D 13 \\ D 21 & D 22 & D 23 \\ D 31 & D 32 & D 33\end{matrix} ] \cdot [ \begin{matrix}α * A \\ β * B \\ γ * C\end{matrix} ] + [ \begin{matrix}Offsetx \\ Offsety \\ Offsetz\end{matrix} ] & Formula ( 1 ) \\ [ \begin{matrix}α * A \\ β * B \\ γ * C\end{matrix} ] = [ \begin{matrix}C 11 & C 12 & C 13 \\ C 21 & C 22 & C 23 \\ C 31 & C 32 & C 33\end{matrix} ] \cdot [ \begin{matrix}X \\ Y \\ Z\end{matrix} ] + [ \begin{matrix}OffsetA \\ OffsetB \\ OffsetC\end{matrix} ] & Formula ( 2 )\end{matrix}$$

where D11 to D33 and C11 to C33 are transformation coefficients, and Offsetx to Offsetz and OffsetA to OffsetC are transformation constants.

Step 210: assume the gain value α, β, and γ are 1 in a black, red, green, and blue frame, and utilize the optical sensor 28 to detect the light source 22 so as to obtain color parameters as follows:

Black frame: A0, B0, C0

Red frame: A1, B1, C1

Green frame: A2, B2, C2

Blue frame: A3, B3, C3

In addition, utilize a color meter to measure the display module 21 so as to obtain three tri-stimulus values as follows:

Black frame: X0, Y0, Z0

Red frame: X1, Y1, Z1

Green frame: X2, Y2, Z2

Blue frame: X3, Y3, Z3

Step 220: in the black frame, X0, Y0, Z0 are 0;

$$[ \begin{matrix}α * A \\ β * B \\ γ * C\end{matrix} ] = [ \begin{matrix}C 11 & C 12 & C 13 \\ C 21 & C 22 & C 23 \\ C 31 & C 32 & C 33\end{matrix} ] \cdot [ \begin{matrix}0 \\ 0 \\ 0\end{matrix} ] + [ \begin{matrix}OffsetA \\ OffsetB \\ OffsetC\end{matrix} ] \qquad Formula ( 3 )$$

$$⇒ [ \begin{matrix}OffsetA \\ OffsetB \\ OffsetC\end{matrix} ] = [ \begin{matrix}α * A 0 \\ β * B 0 \\ γ * C 0\end{matrix} ] \qquad Formula ( 4 )$$

Take the formula (4) into the formula (2):

$$[ \begin{matrix}α * ( A - A 0 ) \\ β * ( B - B 0 ) \\ γ * ( C - C 0 )\end{matrix} ] = [ \begin{matrix}C 11 & C 12 & C 13 \\ C 21 & C 22 & C 23 \\ C 31 & C 32 & C 33\end{matrix} ] \cdot [ \begin{matrix}X \\ Y \\ Z\end{matrix} ] \qquad Formula ( 5 )$$

Step 230: the transformation coefficients C11 to C33 can be calculated by taking the parameters of the red frame, green frame, and blue frame in the formula (5);

$$\begin{matrix}[ \begin{matrix}X 1 & Y 1 & Z 1 \\ X 2 & Y 2 & Z 2 \\ X 3 & Y 3 & Z 3\end{matrix} ] \cdot [ \begin{matrix}C 11 \\ C 12 \\ C 13\end{matrix} ] = [ \begin{matrix}A 1 - A 0 \\ A 2 - A 0 \\ A 3 - A 0\end{matrix} ] & Formula ( 6 ) \\ [ \begin{matrix}X 1 & Y 1 & Z 1 \\ X 2 & Y 2 & Z 2 \\ X 3 & Y 3 & Z 3\end{matrix} ] \cdot [ \begin{matrix}C 21 \\ C 22 \\ C 23\end{matrix} ] = [ \begin{matrix}B 1 - B 0 \\ B 2 - B 0 \\ B 3 - B 0\end{matrix} ] & Formula ( 7 ) \\ [ \begin{matrix}X 1 & Y 1 & Z 1 \\ X 2 & Y 2 & Z 2 \\ X 3 & Y 3 & Z 3\end{matrix} ] \cdot [ \begin{matrix}C 31 \\ C 32 \\ C 33\end{matrix} ] = [ \begin{matrix}C 1 - C 0 \\ C 2 - C 0 \\ C 3 - C 0\end{matrix} ] & Formula ( 8 )\end{matrix}$$

Step 240: obtain the transformation matrix of the gain value α, β, and γ for adjusting the luminance and the color temperature of the image.

$$[ \begin{matrix}α \\ β \\ γ\end{matrix} ] = [ \begin{matrix}\frac{C 11}{( A - A 0 )} & \frac{C 12}{( A - A 0 )} & \frac{C 13}{( A - A 0 )} \\ \frac{C 21}{( B - B 0 )} & \frac{C 22}{( B - B 0 )} & \frac{C 23}{( B - B 0 )} \\ \frac{C 31}{( C - C 0 )} & \frac{C 32}{( C - C 0 )} & \frac{C 33}{( C - C 0 )}\end{matrix} ] \cdot [ \begin{matrix}X \\ Y \\ Z\end{matrix} ] \qquad Formula ( 9 )$$

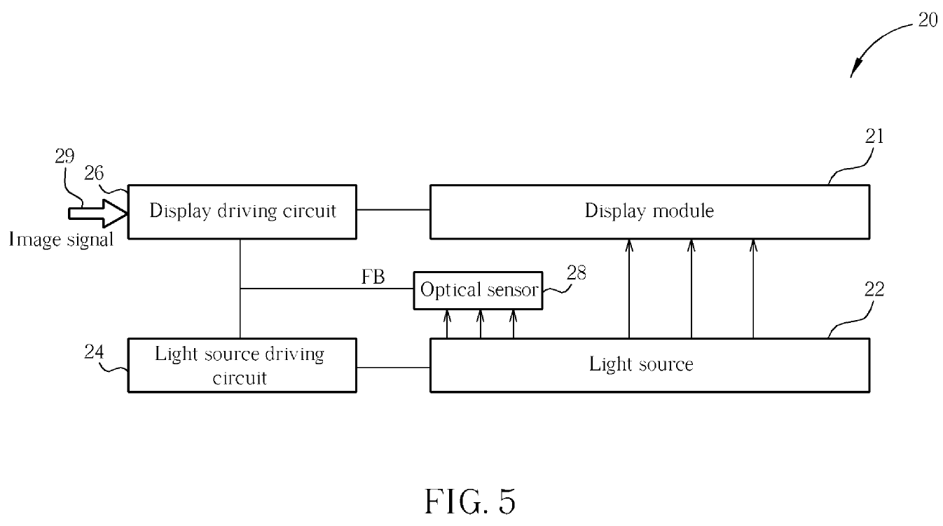

Please refer to FIG. 5. FIG. 5 is a schematic diagram of the third embodiment of a display with a luminance and color temperature control system according to the present invention. In the third embodiment, the optical sensor 28 is coupled to the display driving circuit 26 and the light source driving circuit 24 so that the display driving circuit 26 updates the data of the image signal 29 to adjust the luminance and the color temperature of the image of display module 11 according to the feedback signal FB generated by the optical sensor 28. Similarly, the light source driving circuit 24 also adjusts the luminance of the light source 22 according to the feedback signal FB generated by the optical sensor 28. The feedback loop of the optical sensor 28 coupled to the display driving circuit 26 is a benefit to the display 20 no matter what kind of light source it has, the display driving circuit 26 compensates the luminance and the color temperature of the image of the display 20. However, the luminance of the light source 22 still remains unstable. The feedback loop of the optical sensor 28 coupled to the light source driving circuit 24 stabilizes the luminance of the light source 22. Further, if the light source 22 includes a light-emitting diode (LED) module, the light source driving circuit 24 individually compensates the luminance of the red light, the green light, and the blue light. In this embodiment, if the light source 22 includes a cold cathode fluorescent lamp (CCFL), the display driving circuit 26 individually compensates the luminance of the red pixel, the green pixel, and the blue pixel of the image.

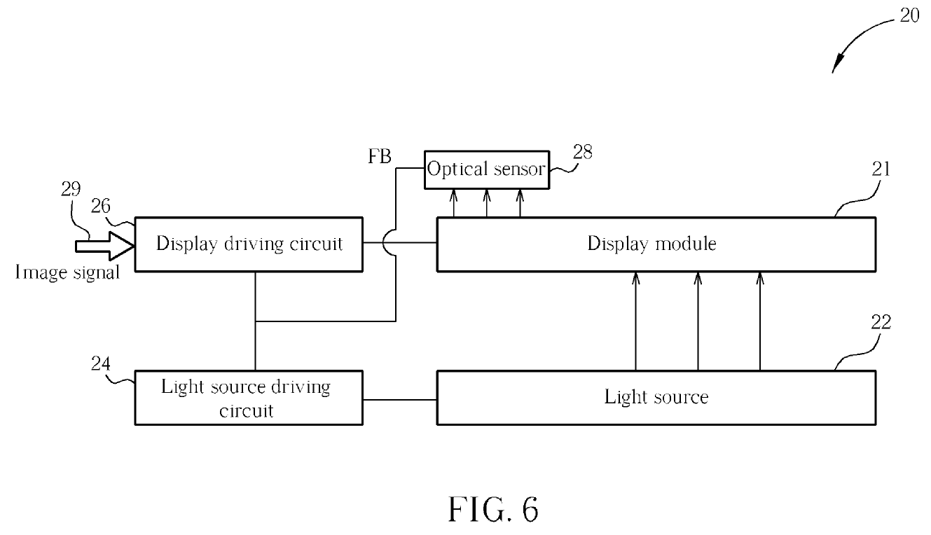

Please refer to FIG. 6. FIG. 6 is a schematic diagram of the fourth embodiment of a display with a luminance and color temperature control system according to the present invention. In the fourth embodiment, the optical sensor 28 is installed on the display surface of the display module 21 for detecting the luminance and the color temperature of the image generated by the display module 21. The optical sensor 28 is coupled to the display driving circuit 26 and the light source driving circuit 24. The optical sensor 28 generates the feedback signal FB to the display driving circuit 26 and the light source driving circuit 24. Thus, the display driving circuit 26 calculates the gain values for updating the data of the image signal 29 according to the feedback signal FB so as to adjust the luminance and the color temperature of the image. In addition, the light source driving circuit 24 adjusts the luminance of the light source 22 according to the feedback signal FB.

In conclusion, the present invention provides a display with a luminance and color temperature control system. The display includes a display module, a light source, a light source driving circuit, a display driving circuit, and an optical sensor. The optical sensor is installed next to the light source for detecting the luminance and the color temperature of the light source. The optical sensor is coupled to the display driving circuit for generating a feedback signal to the display driving circuit according to the luminance and the color temperature of the light source. The display driving circuit drives the display module to display an image according to a received image signal and updates the data of the image signal according to the feedback signal so as to adjust the luminance and color temperature of the image. Further, the optical sensor is coupled to the light source driving circuit so that the light source driving circuit can adjust the luminance of the light source according to the feedback signal generated by the optical sensor so as to stabilize the luminance. The display with any kind of the light source can utilize the display driving circuit to compensate the luminance and the color temperature of the red pixel, the green pixel, and the blue pixel of the image individually.

The foregoing description of the preferred embodiment of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

Those skilled in the art will readily observe that numerous modifications and alterations of the device and method may be made while retaining the teachings of the invention.

What is claimed is:

1. A display with a luminance and color temperature control system, comprising:
a display module;
a light source installed next to the display module;
an optical sensor installed next to the light source for detecting the luminance and the color temperature of the light source so as to generate at least one feedback signal; and
a display driving circuit coupled to the optical sensor for receiving an image signal so as to drive the display module to display an image and updating the data of the image signal according to the feedback signal.

2. The display of claim 1 further comprising a light source driving circuit coupled to the optical sensor for driving the light source and adjusting the luminance of the light source according to the feedback signal.

3. The display of claim 1 wherein the light source comprises a cold cathode fluorescent lamp (CCFL) or a light-emitting diode (LED).

4. The display of claim 1 further comprising an analog to digital converter (ADC) coupled between the optical sensor and the display driving circuit for converting the feedback signal generated by the optical sensor to a digital signal.

5. The display of claim 4 wherein the display driving circuit comprises a scalar coupled to the ADC for converting the image signal to at least one gain value for adjusting the image signal.

6. The display of claim 1 wherein the optical sensor comprises a red light detective unit, a green light detective unit, and a blue light detective unit.

7. A method for controlling the luminance and the color temperature of a display, comprising:
detecting the luminance and the color temperature of a display so as to generate at least one feedback signal; and
updating data of an image signal for driving the display according to the feedback signal so as to adjust the luminance and the color temperature of an image of the display.

8. The method of claim 7 further comprising:
adjusting the luminance of a light source of the display according to the feedback signal.

9. The method of claim 7 further comprising:
converting the feedback signal to a digital signal.

10. The method of claim 9 further comprising:
converting the digital signal to at least one gain value for adjusting the image signal.

11. The method of claim 7 wherein detecting the luminance and the color temperature of the display comprises detecting the luminance and the color temperature of a red light, a green light, and a blue light of a light source of the display.

12. The method of claim 11 wherein the at least one feedback signal comprises three feedback signals, and updating the data of the image signal for driving the display according to the feedback signal comprises updating the data of a red light, a green light, and a blue light of the image signal respectively for driving the display according to the three feedback signals.

13. The method of claim 11 further comprising:
adjusting individually the luminance of the red light, the green light, and the blue light of the light source of the display according to the feedback signal.

14. A display with a luminance and color temperature control system, comprising:
a display module for displaying an image and the display module having a display surface;
an optical sensor installed on the display surface for detecting the luminance and the color temperature of the image so as to generate at least one feedback signal; and
a display driving circuit coupled to the optical sensor for receiving an image signal so as to drive the display module to display the image and updating data of the image signal according to the feedback signal.

15. The display of claim 14 further comprising a light source installed next to the display module.

16. The display of claim 15 further comprising a light source driving circuit coupled to the optical sensor for driving the light source and adjusting the luminance of the light source according to the feedback signal.

17. The display of claim 15 wherein the light source comprises a cold cathode fluorescent lamp (CCFL) or a light-emitting diode (LED).

18. The display of claim 14 further comprising an analog to digital converter (ADC) coupled between the optical sensor and the display driving circuit for converting the feedback signal generated by the optical sensor to a digital signal.

19. The display of claim 18 wherein the display driving circuit comprises a scalar coupled to the ADC for converting the image signal to at least one gain value for adjusting the image signal.

20. The display of claim 14 wherein the display comprises a liquid crystal display (LCD) or a plasma display.
